(19) United States
(12) Patent Application Publication
(10) Pub. No.: US 2007/0115393 A1
(43) Pub. Date: May 24, 2007

(54) Video capture system

(75) Inventor: Peter Diamond, Stockport (GB)

Correspondence Address: NOTARO AND MICHALOS, 100 DUTCH HILL ROAD, SUITE 110, ORANGEBURG, NY, 10962-2100, US

(73) Assignee: BAXALL LIMITED, BREDBURY, STOCKPORT, SK6, 2SU (GB)

(21) Appl. No.: 10/555,242

(22) PCT Filed: Apr. 26, 2004
(86) PCT No.: PCT/GB04/01845

§ 371 Date: Feb. 2, 2007

(30) Foreign Application Priority Data
Apr. 30, 2003 (GB) 0309935.5

(51) Int. Cl. H04N 9/64; G09G 5/36

(52) U.S. Cl. 348/718; 345/547

(57) ABSTRACT

A video capture system includes an input for receiving a plurality of analogue video signals; switching mechanisms for selecting any one of the analogue video signals; memory for storing signals output from the switching mechanism; and a system control for extracting signals from the memory at a predetermined rate and transferring the signals to a video Codec mechanism.

The present invention relates to a video capture system and in particular to such a system which has multiple analogue video inputs. One example of such a system is a security system with a plurality of cameras.

A security system which accepts a plurality of analogue video inputs is usually constrained by cost such that all of the video inputs cannot be viewed or recorded at the same time. In the circumstances, the system uses a time division multiplexed front end to capture small samples from each input in turn, for either viewing or recording. This means that only one set of input circuitry is required to capture the signals from all cameras, but that the input rate from each camera is less than real time.

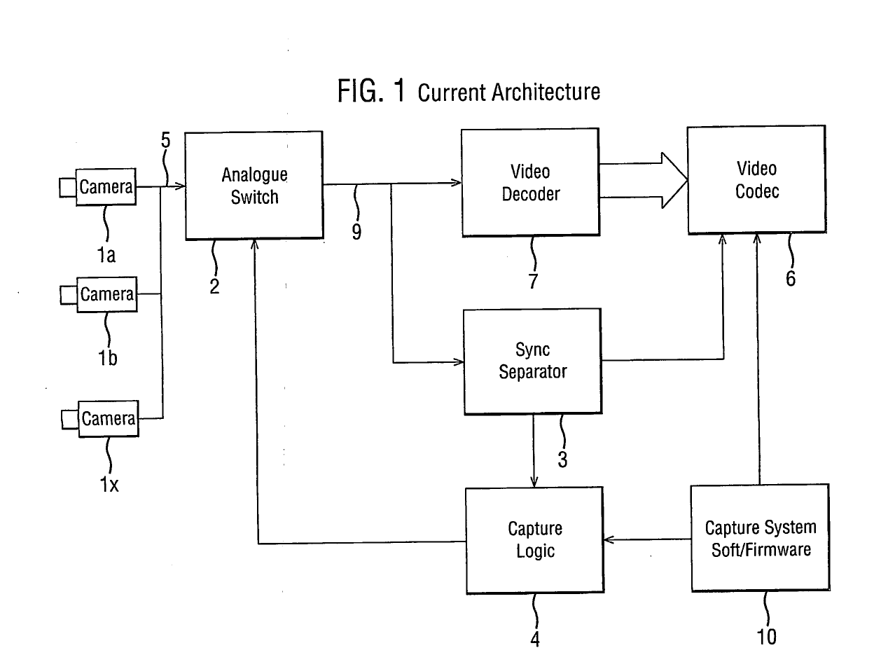

A typical multiplexed video security system includes a plurality of analogue video cameras, from each of which video signals are received by a central system. The central system typically includes a recording device for recording the video images from one of the cameras at a time, and also a monitoring device for viewing the video images from one of the cameras at a time. An example of such a system is shown in FIG. 1.

In FIG. 1, a plurality of analogue video cameras 1a, 1b. . . 1x, feed their respective analogue video signals to an input 5 of an analogue switch 2. The operation of the analogue switch 2 determines which of the cameras is connected to the capture system video input 9. Only one of the cameras at a time is connected to the capture system video input 9 and the capture system may include a video display and/or recorder (not shown).

The analogue switch 2 is controlled by the system software or firmware 10 and capture logic 4. The capture logic 4 receives synchronisation signals filtered from the video data by sync separator 3 so that it can determine when the active region of the current video input is available to be captured. The sync separator is used to convert the synchronisation signals incorporated in the analogue video signals into digital form so that they can be used by the capture logic 4. Once the desired image has been captured, the capture logic indicates that capture is complete and therefore the capture system software/firmware can proceed to capture the next image (e.g. from a different camera) as required.

At the capture system video input 9, the video signals are input to a video decoder 7 which is essentially an analogue to digital converter. The digitised video signals are then passed to a video Codec 6 (a compression and decompression device). The synchronisation signals from the video decoder 7 are used to drive the control mechanism of the video Codec 6. A typical video camera image has a digitised resolution of 864 pixels by 312.5 lines and each of these images is passed to the video Codec 6 in turn, for compression. The Codec 6 uses the synchronisation signals to identify which lines and pixels from the incoming image data to compress. The applicant has realised that the result of this dependence on the synchronisation signals is that no matter what portion or subset of the image merits compression, the time taken for the compression of each image is the same every time, since the compression is constrained by the time base of the incoming signal (i.e. 20 milliseconds for every field of a standard PAL signal).

In more detail, for each individual image capture, the following process is carried out:
1. An appropriate sync signal appears at the output of the sync separator 3. This will usually be a vertical synchronisation signal.
2. The capture logic 4 starts the image capture process.
3. By monitoring the sync separator 3 output, the capture logic 4 counts the image lines until the first image to be collected is complete.
4. The next camera is selected from which an image is to be collected.
5. Repeat steps 1-4 as desired.

However, since the video signals from the cameras are asynchronous with respect to each other, there is no predetermined time period between successive captured images. This causes real time software coding and debugging issues for programmers. Furthermore, the sync signals of the cameras will beat against each other over time and the software/firmware will be interrupted at irregular and indeterminable intervals, causing further problems.

In one example, the capture system would change between the inputs of different cameras in a predetermined order e.g. it would cycle through each camera in turn. Alternatively, the system may be set up to alternate between a pair of cameras, or a larger set of cameras. Furthermore, either of these examples could be set up such that the cycle was interrupted to change to the input of a different camera, e.g. on the request of a user or on the receipt of an alarm condition. In such a case, one or more additional cameras may be added to the sequence, either on an exclusive basis (e.g. recorded on its/their own) or on an interleaved basis e.g. recorded in addition to the existing cameras at the same or a different rate.

Also since there is no predetermined time period (dead time”) between successive captured images, the average capture rate for the system is not accurately specifiable and in any event it changes with the number of cameras connected to the system. Furthermore, the instantaneous capture rate varies with time. In addition, the applicant has realised that the use of the Codec in the prior art architecture is inefficient.

The present invention aims to provide a system which addresses some or all of these problems.

In a first aspect, the present invention provides a video capture system including:—
input means for receiving a plurality of analogue video signals;
switching means for selecting any one of the analogue video signals;
memory means for storing signals output from the switching means; and
system control means for extracting signals from the memory means at a predetermined rate and transferring the signals to video Codec means.

The inclusion of the memory means (which may be termed a “memory buffer” or “throttle buffer”) in the system effectively enables the asynchronous input signals to be synchronised, thereby delivering a deterministic system which reduces software complexity and debugging problems.

Preferably there is only one memory means i.e. the memory means is usable to store signals from all of the input means.

Preferably the system control means is usable for extracting signals from the memory means in a predetermined order, with predetermined dimensions and/or with a predetermined rate. The predetermined order may be different from the order in which the signals input to the memory and the memory means.

Preferably the video capture system includes digitising means for digitising the signals output from the switching means prior to storage in the memory means.

Preferably switching control means controls the operation of the switching means and may be operated independently of the system control means so that, for example, the switching control means can control the capture of the analogue video signals and, in some examples, their subsequent storage in the memory means in an asynchronous manner at whatever rate is appropriate. Independently of the storage of the signals in the memory means, the system control means may then extract signals from the memory means at the predetermined rate e.g. a chosen “clock” rate to suit any video processing system to which the signals may then be sent. Preferably the predetermined rate of extracting signals from the memory means is approximately the same as the average input rate of the storing of signals in the memory means, so that the memory means will not overflow or empty.

Preferably the switching control means and/or the system control means is/are operable so that the memory means may be written to and read from simultaneously.

Preferably the system control means controls the memory means and/or the digitising means such that only a portion of each signal output from the switching means is stored in the memory means. For example, a portion or portions of an image which contain no picture information (such as the blanking regions) may be ignored and either not digitised by the digitising means and/or not stored by the memory means. Additionally or alternatively, the full image and/or a decimated full image may be selected.

Preferably the system control means determines the dimensions of each image to be stored in the memory means and/or controls the output from the memory means such that each buffered image read from the memory means is of predetermined dimensions.

Preferably, the system control means is operable to generate synchronisation signals to control the operation of the digitising means and/or memory means and/or video Codec means and such synchronisation signals may match the predetermined time base and/or dimensions of the images stored in the memory means.

In a further aspect, the present invention provides a method of operating a video capture system, the method including the steps of:

1. receiving analogue video signals from a plurality of sources;

2. selecting a signal from one of the sources;

3. storing the selected signal in memory means;

4. repeating steps 2 and 3 as required; and

5. at the same time as step 2 and/or step 3, extracting signals from the memory means at a predetermined rate and transferring the signals to video Codec means.

Other preferred steps of the method will be apparent from the description of the operation of the apparatus given above and may be used with any or all of the aspects described herein.

In a further aspect, the present invention provides a video security system including:
a video capture system as described above; and
a plurality of analogue video cameras whose signals are fed to the input means of the video capture system.

Embodiments of the present invention will now be described by way of example with reference to the accompanying drawings in which:

FIG. 1 is a schematic diagram of the architecture of a prior art system;

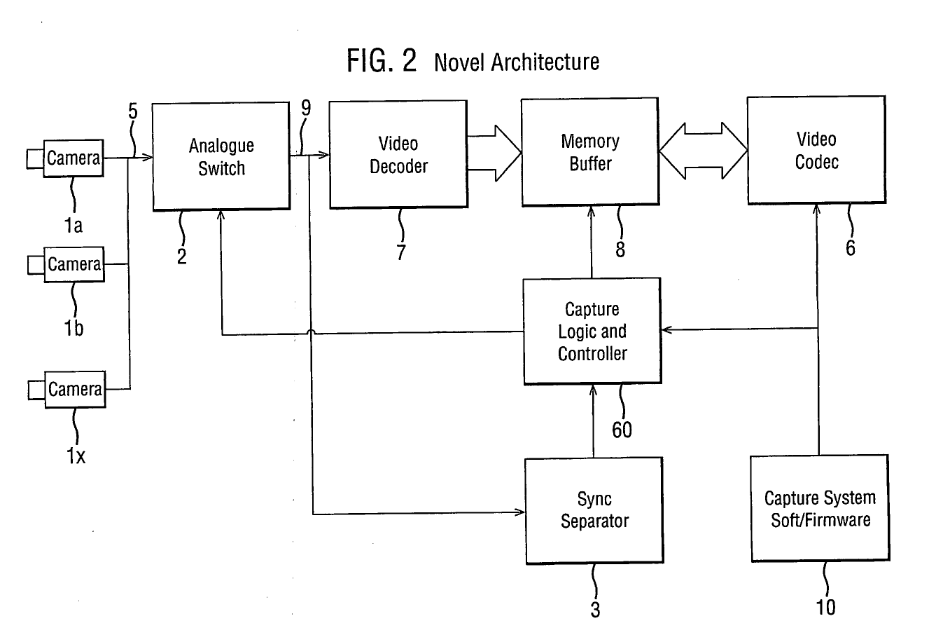

FIG. 2 is a schematic diagram of an embodiment of a video capture system according to the present invention;

FIG. 2 is a schematic diagram of one embodiment of the present invention. A plurality of analogue video cameras 1a, 1b . . . 1X are coupled to an analogue switch 2 so that the respective analogue signals can be fed to the switch. As with the prior art system of FIG. 1, a sync separator 3 monitors the output of the analogue switch 2 to determine properties of the analogue video signal output from analogue switch 2 to the remainder of the capture system 9.

The output of the sync separator 3 is passed to the capture logic and controller 60 (referred to generally as switching control means in this specification) in a similar manner to the prior art of FIG. 1. The capture controller 60 determines the operation of the analogue switch 2, for example so as to select the order in which the analogue video signals from each of the cameras 1a, 1b . . . 1X, is captured, and to select a video signal from one of the video cameras at a time.

The selected video signal is digitised by video decoder 7 and then stored in a memory buffer 8. The capture controller 60 may monitor one or both of (a) the output of the analogue switch 2 (for example so as to be able to detect the start and/or finish of the “active” region of the selected video signal, e.g. via a sync separator 3), and/or (b) the operation (e.g. the input operation) of the memory buffer 8. In this way, the capture controller 60 can optimise the input to the buffer 8.

Data is transferred to/from the buffer 8 at a predetermined rate to/from a video Codec 6.

Preferably the capture logic and controller 60 controls the size of the digitised image in the memory buffer and/or the portion of the original video image received at input 9 which is digitised by video decoder 7 and/or stored in the buffer 8. For example, as mentioned previously, a typical CCR-601 video camera image has a digitised resolution of 864 pixels by 312.5 lines. Of this, a large portion is what is known as “blanking” and contains no actual picture information. The active area of a full size image, from which the area to be compressed in the present invention is actually, for example, 720 pixels by 288 lines. By storing only this smaller image in the memory buffer, for subsequent compression by the video Codec 6, the time taken for compression by the Codec 6 is reduced (in this case by e.g. 23%) i.e. the Codec can be used more efficiently to compress more images in a given amount of time. Taking this further, a decimated image, such as 360 pixels ×144 lines would reduce the time taken for a compression, using this method by 80% over that taken by the old architecture.

Preferably the capture logic and controller 60 also generates synchronisation signals or codes which match the predetermined time base and/or dimensions of the stored images to be read from the buffer 8 to the Codec 6. Preferably the synchronisation signals or codes minimise the amount of non-active data (e.g. non-image data) present in the video stream to the Codec 6.

Similarly, images may also be decompressed using the video Codec 6 and read back into the memory buffer 8. In addition, preferably, images can be read to and from the memory buffer in any order determined by the capture logic and controller 60 and/or the capture system soft/firm ware 10.

Functionally, in preferred embodiments, the capture controller 60 may be able to perform any or all of the following functions:—

a) resize images e.g. as they are output

b) read images from the buffer in a different order to that in which they were written

c) read images at a predetermined rate

d) insert the output data from the buffer into a predetermined time base, which time base may be generated by the capture controller.

The invention may include any variations, modifications and alternative applications of the above embodiments, as would be readily apparent to the skilled person without departing from the scope of the present invention in any of its aspects.

1. A video capture system including:—input means for receiving a plurality of analogue video signals; switching means for selecting any one of the analogue video signals; memory means for storing signals output from the switching means; and system control means for extracting signals from the memory means at a predetermined rate and transferring the signals to video Codec means.

2. A video capture system according to claim 1 including only one memory means, wherein the memory means is usable to store signals from all of the input means.

3. A video capture system according to claim 1 wherein the system control means is usable for extracting signals from the memory means in a predetermined order, with predetermined dimensions and/or with a predetermined rate.

4. A video capture system according to claim 3 wherein the predetermined order is different from the order in which the signals input to the memory and the memory means.

5. A video capture system according to claim 1 including digitising means for digitising the signals output from the switching means prior to storage in the memory means.

6. A video capture system according to claim 1 including switching control means for controlling the operation of the switching means and operatable independently of the system control means.

7. A video capture system according to claim 6 wherein independently of the storage of the signals in the memory means, the system control means is usable to extract signals from the memory means at a predetermined rate.

8. A video capture system according to claim 7 wherein the predetermined rate of extracting signals from the memory means is approximately the same as the average input rate of the storing of signals in the memory means, so that the memory means will not overflow or empty.

9. A video capture system according to claim 6 wherein the switching control means and/or the system control means is/are operable so that the memory means may be written to and read from simultaneously.

10. A video capture system according to claim 1 wherein the system control means controls the memory means and/or the digitising means such that only a portion of each signal output from the switching means is stored in the memory means.

11. A video capture system according to claim 10 wherein a portion or portions of an image which contain no picture information (such as the blanking regions) may be ignored and either not digitised by the digitising means and/or not stored by the memory means.

12. A video capture system according to claim 1 wherein the system control means is operable to determine the dimensions of each image to be stored in the memory means and/or controls the output from the memory means such that each buffered image read from the memory means is of predetermined dimensions.

13. A video capture system according to claim 1 wherein the system control means is operable to generate synchronisation signals to control the operation of the digitising means and/or memory means and/or video Codec means.

14. A video capture system according to claim 13 wherein the synchronisation signals match the predetermined time base and/or dimensions of the images stored in the memory means.

15. A video security system including: a video capture system according to claim 1; and a plurality of analogue video cameras whose signals are fed to the input means of the video capture system.

16. A method of operating a video capture system, the method including the steps of: 1. receiving analogue video signals from a plurality of sources; 2. selecting a signal from one of the sources; 3. storing the selected signal in memory means; 4. repeating steps 2 and 3 as required; and 5. at the same time as step 2 and/or step 3, extracting signals from the memory means at a predetermined rate and transferring the signals to video Codec means.
